(19) United States
(12) Patent Application Publication
(10) Pub. No.: US 2017/0373343 A1
(43) Pub. Date: Dec. 28, 2017

(54) METHOD OF PRODUCING NEGATIVE ELECTRODE PLATE

(71) Applicant: TOYOTA JIDOSHA KABUSHIKI KAISHA, Toyota-shi (JP)

(72) Inventor: Tomoya MESUDA, Toyota-shi (JP)

(73) Assignee: TOYOTA JIDOSHA KABUSHIKI KAISHA, Toyota-shi (JP)

(21) Appl. No.: 15/626,762

(22) Filed: Jun. 19, 2017

(30) Foreign Application Priority Data
Jun. 22, 2016 (JP) 2016-123791

(51) Int. Cl. H01M 10/0525; H01M 4/36; H01M 4/04

(52) U.S. Cl. CPC H01M 10/0525; H01M 4/0435; H01M 4/364

(57) ABSTRACT

A method of producing a negative electrode plate includes mixing a negative electrode mixture material containing a negative electrode active material and a binding material with a solvent and forming a wet granulated body and rolling the wet granulated body to pass through a gap between a pair of rolls, molding the body in a sheet form, and adhering the body to a surface of a negative electrode current collecting foil. Moreover, when the wet granulated body is formed, a powder whose average particle size X μm and tap density Y g/cm³ satisfy Y≧0.0139X+0.4386 is used as a powder of the negative electrode active material.

### INCORPORATION BY REFERENCE

The disclosure of Japanese Patent Application No. 2016-123791 filed on Jun. 22, 2016 including the specification, drawings and abstract is incorporated herein by reference in its entirety.

### BACKGROUND

### 1. Technical Field

The present disclosure relates to a method of producing a negative electrode plate, and more specifically, to a method of producing a negative electrode plate in which a negative electrode mixture material is passed between a pair of rolls, pressed, and molded in a sheet form to form a film forming sheet, and the film forming sheet is adhered to a surface of a negative electrode current collecting foil to produce a negative electrode plate.

### 2. Description of Related Art

A battery such as a lithium ion secondary battery is obtained by accommodating positive and negative electrode plates and an electrolyte in a case. The positive and negative electrode plates include a current collecting foil and an electrode mixture layer. The electrode mixture layer includes an active material contributing to charging and discharging and an electrode mixture material such as a binding material for binding an active material to a current collecting foil to form an electrode mixture layer. Here, as the related art of such a method of producing an electrode plate, for example, Japanese Patent Application Publication No. 2015-201318 (JP 2015-201318 A) may be exemplified.

In JP 2015-201318 A, a method of producing an electrode plate using a wet granulated body formed of an electrode mixture material such as an active material and a binding material, and a solvent is described. That is, in JP 2015-201318 A, a method of producing an electrode plate in which a molded body obtained by molding a wet granulated body in a planar form or block form is passed between a pair of rolls, pressed, and then transferred and adhered to a current collecting foil is described. Accordingly, a boundary between a portion in which an electrode mixture layer is formed on an electrode plate and a portion in which no electrode mixture layer is formed and a current collecting foil is exposed can be formed in a straight line, which is described in the literature.

### SUMMARY

However, in the above technique, when a wet granulated body formed of a negative electrode mixture material is pressed by a pair of rolls, particles of the negative electrode active material compressed by the pressing may be crushed. In addition, specifically, negative electrode active material particles directly in contact with a pair of rolls may be crushed by compressing. That is, negative electrode active material particles that may be crushed by compressing are negative electrode active material particles positioned on a surface of a negative electrode mixture layer in the negative electrode plate. Therefore, since negative electrode active material particles positioned on a surface of the negative electrode mixture layer are crushed, it is not possible to produce a battery having high battery performance using the negative electrode plate.

That is, in a lithium ion secondary battery, a negative electrode mixture layer of a negative electrode plate in which a lithium ion occlusion and release reaction occurs smoothly not only between an electrolyte positioned on its surface and itself but also between an electrolyte contained in voids inside the negative electrode mixture layer and itself is preferable. This is because, when an area in which a charge and discharge reaction occurs is wide, an internal resistance of a battery is reduced. In addition, in order for a lithium ion occlusion and release reaction to occur satisfactorily between the negative electrode mixture layer and an electrolyte contained in voids therein, it is preferable that openings connected to voids inside the negative electrode mixture layer be appropriately formed on the surface of the negative electrode mixture layer. This is because this enables lithium ion conductivity between an electrolyte outside the negative electrode mixture layer and an electrolyte contained in voids inside the negative electrode mixture layer to be increased.

However, when negative electrode active material particles on the surface of the negative electrode mixture layer are crushed, openings on the surface of the negative electrode mixture layer connected to voids may be blocked due to the crushed negative electrode active material particles. Then, while openings on the surface of the negative electrode mixture layer connected to voids are blocked, lithium ion conductivity between an electrolyte outside the negative electrode mixture layer and an electrolyte contained in voids inside the negative electrode mixture layer is lowered. This is because conduction of lithium ions is inhibited. That is, in the negative electrode plate in which negative electrode active material particles positioned on the surface of the negative electrode mixture layer are crushed, there are problems in that an area in which a charge and discharge reaction occurs in the battery becomes narrower and an internal resistance of the battery becomes higher.

The present disclosure provides a method of producing a negative electrode plate through which it is possible to reduce an internal resistance of a battery.

An aspect of the present disclosure relates to a method of producing a negative electrode plate including a negative electrode mixture layer on a negative electrode current collecting foil. The aspect of the present disclosure includes mixing a negative electrode mixture material containing a negative electrode active material and a binding material with a solvent, forming a wet granulated body, rolling the wet granulated body to pass through a gap between a pair of rolls, molding the wet granulated body in a sheet form, and adhering the wet granulated body molded in the sheet form to a surface of the negative electrode current collecting foil. When the wet granulated body is formed, a powder whose average particle size X μm and tap density Y g/cm³ satisfy the following formula: Y≧0.0139X+0.4386, is used as a powder of the negative electrode active material.

According to the aspect of the present disclosure, when the wet granulated body is formed, a powder whose average particle size and tap density satisfy the above formula is used as a powder of the negative electrode active material. That is, a powder whose tap density is equal to or greater than a predetermined value determined by an average particle size is used. In general, in the powder, higher tap density indicates higher flowability. Here, if a powder of a negative electrode active material having a high tap density and flowability is used, when the negative electrode mixture layer is formed, it is possible to prevent negative electrode active material particles on the surface of the negative electrode mixture layer from being crushed due to a compression force received from a pair of rolls. Therefore, it is possible to produce a negative electrode plate while preventing openings on the surface of the negative electrode mixture layer connected to voids inside the negative electrode mixture layer from being blocked. Accordingly, it is possible to produce a battery having a low internal resistance using the negative electrode plate.

In addition, in the above aspect, when the wet granulated body is formed, a powder having a tap density of 1.2 g/cm³ or less may be used as the powder of the negative electrode active material. This is because, when the negative electrode mixture layer is formed, if a wet granulated body formed using a negative electrode active material powder whose tap density is 1.2 g/cm³ or less is used, it is possible to appropriately form the negative electrode mixture layer on the negative electrode current collecting foil.

In addition, in the above aspect, when the wet granulated body is formed, a weight of the negative electrode mixture material with respect to a total weight of the negative electrode mixture material and the solvent may be 72 wt % or more. This is because, when an amount of a solvent component used is reduced, it is possible to produce a negative electrode plate in a short time at a low cost.

In addition, in the method of producing a negative electrode plate described above, when the wet granulated body is formed, the weight of the negative electrode mixture material with respect to the total weight of the negative electrode mixture material and the solvent may be 80 wt % or less. This is because it is possible to appropriately form the wet granulated body without deficiency of the solvent.

According to the present disclosure, there is provided a method of producing a negative electrode plate through which it is possible to reduce an internal resistance of a battery.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a cross-sectional view of a negative electrode plate;

FIG. 2 is a diagram showing procedures of producing a negative electrode plate;

FIG. 3 is a schematic configuration diagram of a mixture layer forming device that is used in a negative electrode mixture layer forming process;

FIG. 4 is a diagram showing relationships of an average particle size and a tap density of a negative electrode active material powder, and an initial internal resistance of a battery;

FIG. 5 is a diagram showing a relationship between an average particle size and a tap density at which a non-defective battery can be produced;

FIG. 6 is an enlarged view of a first opposing position in a mixture layer forming device;

FIG. 7 is a cross-sectional view of a negative electrode mixture layer that is formed using a negative electrode active material powder having a low tap density;

FIG. 8 is a cross-sectional view of a negative electrode mixture layer that is formed using a negative electrode active material powder having a high tap density; and

FIG. 9 is a diagram showing initial internal resistances of an example and comparative examples.

### DETAILED DESCRIPTION OF EMBODIMENTS

Exemplary modes of the present disclosure will be described in detail with reference to the drawings.

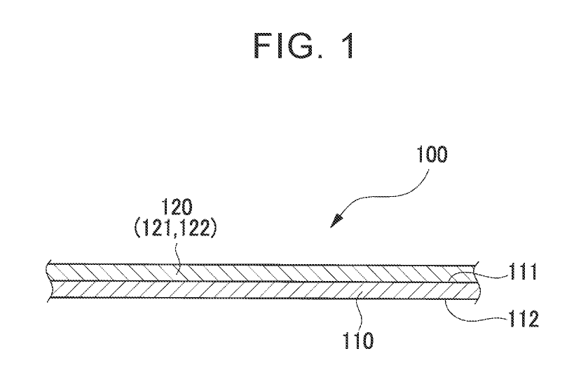

First, a negative electrode plate 100 produced in the present embodiment will be described with reference to FIG. 1. The negative electrode plate 100 includes a negative electrode current collecting foil 110 and a negative electrode mixture layer 120 as shown in a cross-sectional view of FIG. 1. The negative electrode plate 100 is long in a horizontal direction in FIG. 1. In the negative electrode plate 100 of the present embodiment, the negative electrode mixture layer 120 is formed only on a first surface 111 of the negative electrode current collecting foil 110. The negative electrode plate 100 of the present embodiment is used for a negative electrode of a lithium ion secondary battery.

In the present embodiment, the negative electrode current collecting foil 110 is a copper foil. In addition, the negative electrode mixture layer 120 includes at least a negative electrode active material 121 and a binding material 122 as a negative electrode mixture material. In the lithium ion secondary battery, the negative electrode active material 121 occludes and releases lithium ions and thus contributes to charging and discharging. In addition, the binding material 122 binds materials forming the negative electrode mixture layer 120 to form the negative electrode mixture layer 120 and binds the negative electrode mixture layer 120 to the first surface 111 of the negative electrode current collecting foil 110.

In the present embodiment, a carbon-based material is used as the negative electrode active material 121. Specifically, in the present embodiment, graphite is used as the negative electrode active material 121. In addition, in the present embodiment, carboxymethyl cellulose (CMC) is used as the binding material 122. Note that a copper foil, graphite, and CMC are only examples, and other materials can be used.

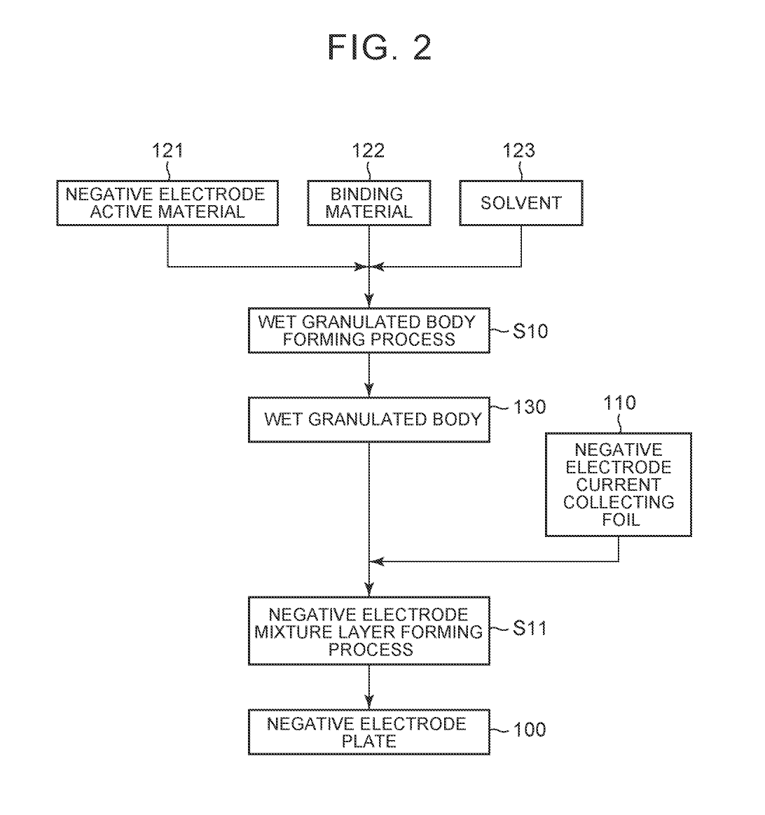

Next, a method of producing the negative electrode plate 100 according to the present embodiment will be described. In the present embodiment, the negative electrode plate 100 is produced according to procedures shown in FIG. 2. That is, in the present embodiment, first, a wet granulated body forming process (S10) is performed. In the wet granulated body forming process, as shown in FIG. 2, a wet granulated body 130 is formed.

The wet granulated body 130 is a material for forming the negative electrode mixture layer 120. Therefore, in the wet granulated body forming process, as shown in FIG. 2, the negative electrode active material 121 and the binding material 122 which are negative electrode mixture materials are used. Further, in the wet granulated body forming process, in order to form the wet granulated body 130, a solvent 123 is used in addition to the negative electrode mixture materials. In the present embodiment, water is used as the solvent 123.

In the wet granulated body forming process, the negative electrode active material 121, the binding material 122, and the solvent 123 are mixed to form the wet granulated body 130. The mixing can be performed using, for example, a stirring device. Then, the negative electrode active material 121 and the binding material 122 which are mixed in a wet state in which the solvent 123 is mixed are uniformly mixed, particles are adhered to each other, and thus the wet granulated body 130 is formed.

In the wet granulated body forming process of the present embodiment, a powder whose average particle size X [μm] and tap density Y [g/cm³] satisfy the following Formula (1) is used as a powder of the negative electrode active material 121.

Y≧0.0139X+0.4386 (1)

Also, in the present embodiment, an average particle size of the powder of the negative electrode active material 121 is a median size that is a particle size at a cumulative value of 50% in the volume-based particle size distribution obtained using a laser diffraction and scattering method.

In addition, a tap density of the negative electrode active material 121 in the present embodiment is determined when a powder of the negative electrode active material 121 is fully filled in a tap cell of a powder density measuring device, tapping is then performed on the tap cell a plurality of times, and a volume and a weight are obtained from the tapped powder of the negative electrode active material 121 for determining the tap density. In the present embodiment, a tap cell with a diameter of 1.6 cm and a volume capacity of 20 cm³ is used. In addition, the filling of the powder of the negative electrode active material 121 into the tap cell is performed by dropping a powder of the negative electrode active material 121 into the tap cell through a sieve having a sieve opening of 300 μm. Here, the tapping is performed under conditions of a stroke length of 10 mm and a tap count of 1000.

After the wet granulated body forming process (S10), in the present embodiment, as shown in FIG. 2, a negative electrode mixture layer forming process (S11) is performed. In the negative electrode mixture layer forming process, the negative electrode mixture layer 120 is formed on a surface of the negative electrode current collecting foil 110 using the wet granulated body 130 and the negative electrode plate 100 is produced.

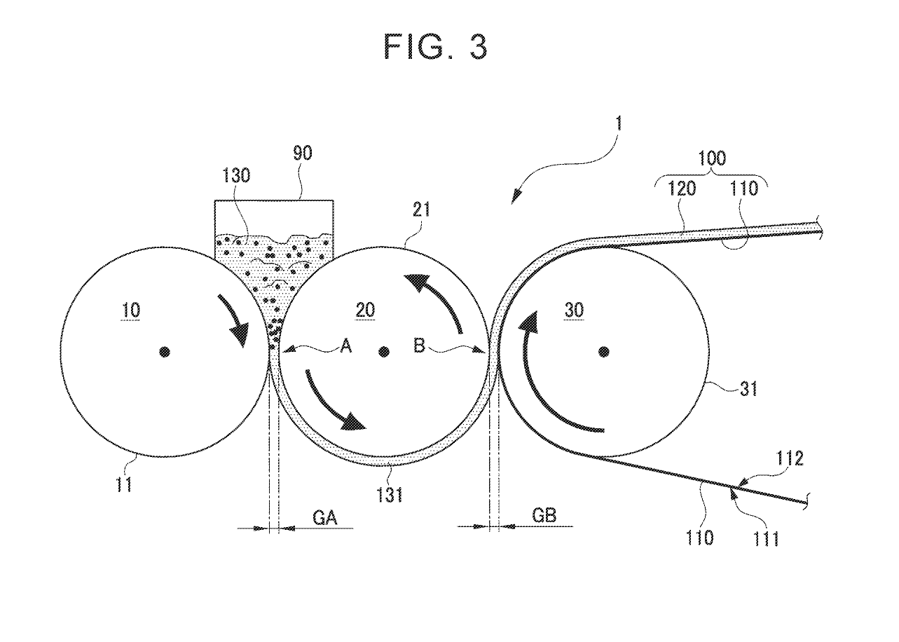

FIG. 3 shows a mixture layer forming device 1 that is used in the negative electrode mixture layer forming process. As shown in FIG. 3, the mixture layer forming device 1 includes a first roll 10, a second roll 20, and a third roll 30. In FIG. 3, an up-and-down direction is a vertical direction, and the force of gravity is exerted downward.

In the mixture layer forming device 1 of the present embodiment, all of the first roll 10, the second roll 20, and the third roll 30 are disposed with axial directions thereof oriented horizontally. The first roll 10, the second roll 20, and the third roll 30 are made of, for example, a metal material. In addition, the first roll 10 and the second roll 20 are disposed in parallel while their outer peripheral surfaces 11 and 21 face each other at the first opposing position A. In addition, the third roll 30 is disposed in parallel with the second roll 20 while an outer peripheral surface 31 faces the outer peripheral surface 21 of the second roll 20 at a second opposing position B.

The first roll 10 and the second roll 20 are held to maintain a constant interaxis distance. Thereby, a gap GA is provided between the outer peripheral surface 11 of the first roll 10 and the outer peripheral surface 21 of the second roll 20 at a first opposing position A. In addition, the third roll 30 is held to maintain a constant interaxis distance from the second roll 20. Thereby, a gap GB is provided between the outer peripheral surface 21 of the second roll 20 and the outer peripheral surface 31 of the third roll 30 at the second opposing position B.

When the negative electrode plate 100 is produced, the first roll 10, the second roll 20, and the third roll 30 rotate. In FIG. 3, directions of rotation of the first roll 10, the second roll 20, and the third roll 30 are indicated by arrows. That is, in FIG. 3, the directions of rotation of the first roll 10 and the third roll 30 are clockwise and the direction of rotation of the second roll 20 is counterclockwise.

The directions of rotation of the first roll 10 and the second roll 20 are directions in which movement directions of the outer peripheral surfaces 11 and 21 are the same at the first opposing position A. Specifically, the directions of rotation of the first roll 10 and the second roll 20 are directions in which movement directions of the outer peripheral surfaces 11 and 21 are both vertically downward at the first opposing position A. In addition, the direction of rotation of the third roll 30 is a direction in which the movement direction of the outer peripheral surface 31 is the same as the movement direction of the outer peripheral surface 21 of the second roll 20 at the second opposing position B.

In addition, in the present embodiment, the second roll 20 rotates at a higher peripheral velocity than the first roll 10. Also, the third roll 30 rotates at a higher peripheral velocity than the second roll 20. That is, the first roll 10, the second roll 20, and the third roll 30 are listed in ascending order of peripheral velocity of rotation.

In addition, a partition portion 90 is provided above the first opposing position A. The partition portion 90 is an enclosure for preventing the wet granulated body 130 from spilling down from upper surfaces of the first roll 10 and the second roll 20. Thereby, the wet granulated body 130 accumulates inside the partition portion 90. The wet granulated body 130 is supplied to the first opposing position A from the inside of the partition portion 90 due to rotation of the first roll 10 and the second roll 20.

In addition, as shown in FIG. 3, the negative electrode current collecting foil 110 is wound on the outer peripheral surface 31 of the third roll 30. The negative electrode current collecting foil 110 is wound on the third roll 30 at the second opposing position B while a second surface 112 faces the outer peripheral surface 31 of the third roll 30. Therefore, the negative electrode current collecting foil 110 is conveyed by rotation of the third roll 30.

In addition, the first surface 111 of the negative electrode current collecting foil 110 faces the outer peripheral surface 21 of the second roll 20 at the second opposing position B. Also, as described above, the third roll 30 rotates at a higher peripheral velocity than the second roll 20. Therefore, a movement speed of the first surface 111 of the negative electrode current collecting foil 110 at the second opposing position B is higher than a movement speed of the outer peripheral surface 21 of the second roll 20 at the second opposing position B.

In addition, the negative electrode current collecting foil 110 is conveyed such that it is supplied into the mixture layer forming device 1 from the lower right side on the third roll 30 in FIG. 3, passes the second opposing position B, and is then discharged to the upper right side on the third roll 30. When the negative electrode current collecting foil 110 is supplied to the mixture layer forming device 1, nothing is formed on the first surface 111 thereof. Thereby, when the mixture layer forming device 1 forms the negative electrode mixture layer 120 on the first surface 111 of the negative electrode current collecting foil 110 at the second opposing position B, it is possible to produce the negative electrode plate 100.

Next, the negative electrode mixture layer forming process (S11) using the mixture layer forming device 1 will be described. In the negative electrode mixture layer forming process, the wet granulated body 130 supplied into the partition portion 90 is sent to the first opposing position A due to rotation of the first roll 10 and the second roll 20 in order from a downstream end.

The wet granulated body 130 that has reached the first opposing position A passes through the gap GA due to rotation of the first roll 10 and the second roll 20 and is pressed between the outer peripheral surface 11 of the first roll 10 and the outer peripheral surface 21 of the second roll 20 when passing through the gap GA. Due to the pressing, the wet granulated body 130 is rolled and particles in the wet granulated body 130 are bound to each other due to an action of the binding material 122. Accordingly, the wet granulated body 130 that has passed the first opposing position A is molded in a sheet form and a film forming sheet 131 is obtained.

In addition, the film forming sheet 131 is adhered to a surface on which a movement speed at the first opposing position A is higher between the outer peripheral surface 11 of the first roll 10 and the outer peripheral surface 21 of the second roll 20. Here, as described above, in the mixture layer forming device 1, the second roll 20 has a higher peripheral velocity than the first roll 10. That is, the film forming sheet 131 formed at the first opposing position A is adhered to the outer peripheral surface 21 of the second roll 20 after passing the first opposing position A. The film forming sheet 131 adhered to the outer peripheral surface 21 of the second roll 20 is conveyed by rotation of the second roll 20 and reaches the second opposing position B.

In addition, the negative electrode current collecting foil 110 is caused to pass the second opposing position B. Thereby, the film forming sheet 131 that has reached the second opposing position B due to rotation of the second roll 20 passes through the gap GB at the second opposing position B together with the negative electrode current collecting foil 110. The negative electrode current collecting foil 110 and the film forming sheet 131 are pressed by the second roll 20 and the third roll 30 in their thickness directions while passing through the gap GB.

At the second opposing position B also, the pressed film forming sheet 131 is adhered to a surface on which a movement speed is higher at the second opposing position B between the outer peripheral surface 21 of the second roll 20 and the first surface 111 of the negative electrode current collecting foil 110. Here, as described above, the third roll 30 in the mixture layer forming device 1 rotates at a peripheral velocity at which a movement speed of the first surface 111 of the negative electrode current collecting foil 110 at the second opposing position B is higher than a peripheral velocity of the second roll 20. Therefore, the film forming sheet 131 that has passed the second opposing position B is transferred onto the first surface 111 of the negative electrode current collecting foil 110 from the outer peripheral surface 21 of the second roll 20.

Accordingly, as shown in FIG. 3, the negative electrode mixture layer 120 is formed on the first surface 111 of the negative electrode current collecting foil 110 after passing the second opposing position B. Thereby, in the mixture layer forming device 1, the first roll 10, the second roll 20, and the third roll 30 are successively rotated, and thus the negative electrode mixture layer forming process continues. Therefore, the negative electrode plate 100 having a long length in a conveyance direction of the negative electrode current collecting foil 110 is produced.

In addition, the negative electrode plate 100 is appropriately cut to a suitable size when it is used to produce a lithium ion secondary battery. Moreover, when the negative electrode plate 100 cut to a suitable size and a positive electrode plate are stacked with a separator therebetween, it is possible to produce an electrode body. Thereby, when the electrode body is accommodated in a battery case together with an electrolyte containing a lithium salt, a lithium ion secondary battery is produced.

Here, in the wet granulated body forming process of the present embodiment, as described above, as a powder of the negative electrode active material 121, a powder whose average particle size X [μm] and tap density Y [g/cm³] satisfy Formula (1) is used. Formula (1) is based on initial internal resistances of a plurality of lithium ion secondary batteries prepared in advance. This will be described below.

First, the inventors prepared a plurality of lithium ion secondary batteries using powders of a plurality of types of negative electrode active materials whose average particle sizes and tap densities were different. Here, all of the lithium ion secondary batteries were prepared using the same material and method except that negative electrode active materials used had different average particle sizes and tap densities. In addition, all of the negative electrode plates were prepared when the above wet granulated body forming process was performed using negative electrode active material powders whose average particle sizes and tap densities were different and the above negative electrode mixture layer forming process was additionally performed.

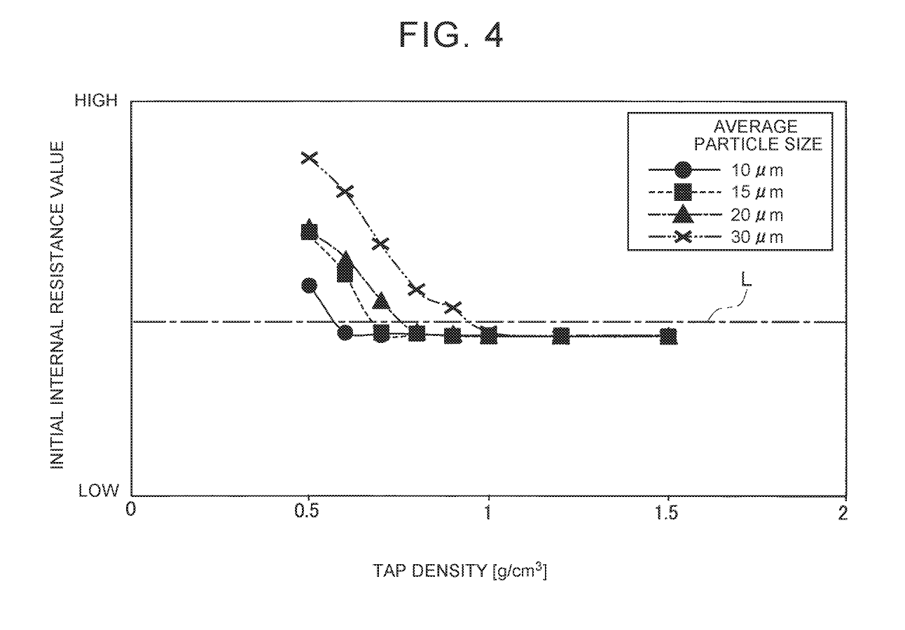

FIG. 4 is a diagram showing initial internal resistance values measured for the prepared lithium ion secondary batteries. In FIG. 4, the horizontal axis represents a tap density of a negative electrode active material powder used in a lithium ion secondary battery and the vertical axis represents a measurement value of an initial internal resistance measured for a lithium ion secondary battery. In FIG. 4, each average particle size is indicated by a different marker. In addition, in a line graph connecting markers, a line type is different for each average particle size.

In addition, a resistance non-defective determination line L is shown in FIG. 4. The resistance non-defective determination line L is a boundary line that is used to determine that a battery has a low initial internal resistance and is non-defective. That is, in the present embodiment, a lithium ion secondary battery whose initial internal resistance value is equal to or less than that of the resistance non-defective determination line L is determined as a non-defective battery. Also, as shown in FIG. 4, it can be understood that, in a battery determined as a non-defective battery, a negative electrode active material powder whose tap density range was higher than an intersection at the resistance non-defective determination line L along the line graph for each average particle size was used.

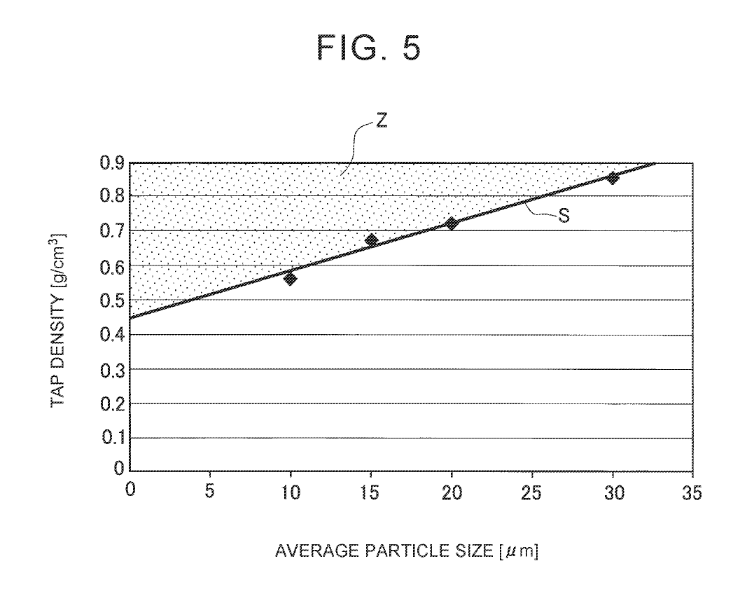

FIG. 5 is a plot diagram showing a plurality of relationships of an average particle size and a tap density along the resistance non-defective determination line L in FIG. 4. In addition, in FIG. 5, an approximate straight line S of a plurality of plotted points is shown. As can be understood from FIG. 5, the approximate straight line S has an extremely strong correlation with a trend of a plurality of points plotting relationships between an average particle size and a tap density along the resistance non-defective determination line L.

In addition, the approximate straight line S is represented by the average particle size X and the tap density Y. Here, the approximate straight line S is drawn when the equality is satisfied in Formula (1). In addition, as described above, in a non-defective battery, a negative electrode active material powder whose tap density range was higher than an intersection at the resistance non-defective determination line L along the line graph for each average particle size in FIG. 4 was used. Therefore, in FIG. 5, the non-defective battery is obtained using a powder whose tap density Y is within a range of a region Z at or above the approximate straight line S as a powder of the negative electrode active material. Accordingly, in the present embodiment, the negative electrode active material 121 whose average particle size X and tap density Y satisfy Formula (1) is used. This is because, when the negative electrode active material satisfying Formula (1) is used, it is possible to produce a non-defective lithium ion secondary battery having a low internal resistance.

In addition, the negative electrode active material satisfying Formula (1) has a tap density that is equal to or greater than a predetermined value determined by the average particle size, that is, has a high tap density. In general, in the powder, as the tap density becomes higher, the flowability of particles in the powder tends to be higher. That is, in the present embodiment, a negative electrode active material having a high tap density and flowability is used. Therefore, in the present embodiment, when the negative electrode active material having a high tap density and flowability is used, it is considered possible to produce a lithium ion secondary battery having a low internal resistance. This will be described below.

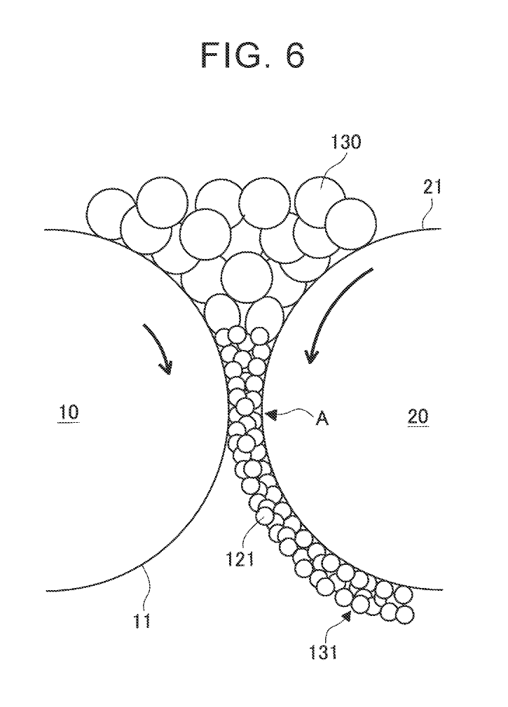

FIG. 6 is an enlarged view of the first opposing position A in the mixture layer forming device 1 in the negative electrode mixture layer forming process. As shown in FIG. 6, at the first opposing position A, the wet granulated body 130 is supplied from above. In addition, granulated particles of the wet granulated body 130 that have moved to the first opposing position A due to rotation of the first roll 10 and the second roll 20 are rolled by compression of the first roll 10 and the second roll 20, and thus are decomposed to particles of the negative electrode active material 121. Then, the particles of the negative electrode active material 121 are adhered to each other and thus the film forming sheet 131 is formed. Here, a side surface in contact with the second roll 20 of the film forming sheet 131 is a side surface far from the negative electrode current collecting foil 110 in the negative electrode mixture layer 120 of the negative electrode plate 100. This is because the film forming sheet 131 is transferred onto the negative electrode current collecting foil 110 from the second roll 20 at the second opposing position B.

Here, unlike the present embodiment, a case in which a negative electrode active material having a low tap density and flowability is used will be described. When the negative electrode active material has a low flowability, negative electrode active material particles compressed on the outer peripheral surface 21 of the second roll 20 at the first opposing position A directly receive a compression force from the outer peripheral surface 21. Then, the negative electrode active material particles that have received a strong compression force from the outer peripheral surface 21 of the second roll 20 are deformed due to the compression force.

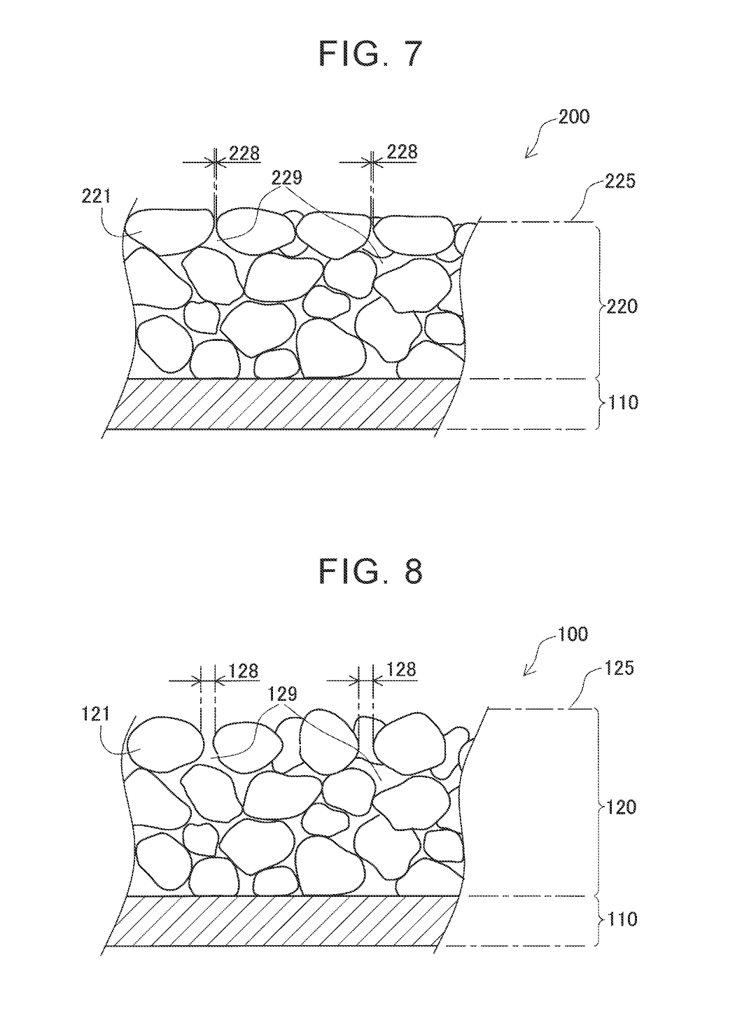

FIG. 7 is a cross-sectional view of a negative electrode plate 200 that is prepared using a negative electrode active material 221 having a low flowability. The negative electrode active material 221 shown in FIG. 7 failed to satisfy Formula (1). As shown in FIG. 7, in the negative electrode plate 200, in particles of the negative electrode active material 221 positioned on a surface 225 of a negative electrode mixture layer 220, parts thereof on the surface 225 are flattened. This is because particles of the negative electrode active material 221 having a low flowability receive a compression force from the second roll 20 at the first opposing position A in the mixture layer forming device 1 and are crushed and flattened.

In addition, the particles of the negative electrode active material 221 that have received a compression force from the second roll 20 are crushed and spread in an in-plane direction of the surface 225. Therefore, as shown in FIG. 7, all gaps 228 among particles of the negative electrode active material 221 adjacent to each other near the surface 225 of the negative electrode mixture layer 220 are very narrow. In addition, depending on parts of the negative electrode mixture layer 220, the gap 228 is blocked and a void 229 inside the negative electrode mixture layer 220 is separated from a space outside the negative electrode mixture layer 220.

Thereby, in the lithium ion secondary battery prepared using the negative electrode plate 200 including the negative electrode mixture layer 220, lithium ion conductivity between an electrolyte outside the negative electrode mixture layer 220 and an electrolyte in the void 229 inside the negative electrode mixture layer 220 is lowered. This is because conduction of lithium ions is inhibited due to the narrow gap 228. Therefore, a lithium ion occlusion and release reaction does not occur satisfactorily between an electrolyte in the void 229 and the negative electrode active material 221 surrounding the void 229 during charging and discharging. Therefore, it is considered that, when the negative electrode active material 221 that has a low tap density and fails to satisfy Formula (1) is used, a reaction area during charging and discharging in the negative electrode mixture layer 220 of the negative electrode plate 200 is not sufficient and the internal resistance of the lithium ion secondary battery becomes higher.

On the other hand, FIG. 8 is a cross-sectional view of the negative electrode plate 100 prepared using the negative electrode active material 121 that satisfies Formula (1) according to the present embodiment and has a high tap density and flowability. As shown in FIG. 8, when the negative electrode active material 121 satisfying Formula (1) is used, it is possible to produce the negative electrode plate 100 without crushing the negative electrode active material 121 positioned on a surface 125 of the negative electrode mixture layer 120. When particles of the negative electrode active material 121 having a high flowability receive a compression force from the second roll 20 at the first opposing position A in the mixture layer forming device 1, they can move smoothly without opposing the compression force. Therefore, the particles are not deformed due to a compression force from the second roll 20.

Here, a shear adhesion strength between the wet granulated body 130 formed of the negative electrode active material 121 satisfying Formula (1) according to the present embodiment and the outer peripheral surface 21 of the second roll 20 was low at 0.1 kPa or less. The shear adhesion strength was measured using a powder bed shear stress measurement device (NS-S commercially available from Nano Seeds Corporation) at a shear rate of 100 μm/s, a vertical stress of 50 kPa to 130 kPa, and a cell diameter (a diameter of a sample in a plane orthogonal to a direction of the vertical stress) of 15 mm. Then, based on the measurement result, it was confirmed that the particles of the negative electrode active material 121 satisfying Formula (1) could slide on the outer peripheral surface 21 of the second roll 20 and move satisfactorily. In addition, a shear adhesion strength between granulated particles of the wet granulated body 130 formed of the negative electrode active material 121 satisfying Formula (1) according to the present embodiment, which was measured under the same conditions as above, was 10 kPa or less. That is, it was confirmed that the wet granulated body 130 formed of the negative electrode active material 121 satisfying Formula (1) had a low shear adhesion strength between particles thereof.

Here, in the negative electrode plate 100 according to the present embodiment, as shown in FIG. 8, gaps 128 among particles of the negative electrode active material 121 adjacent to each other near the surface 125 of the negative electrode mixture layer 120 are wider than those of FIG. 7. Therefore, in a lithium ion secondary battery using the negative electrode plate 100 of the present embodiment, lithium ion conductivity between an electrolyte outside the negative electrode mixture layer 120 and an electrolyte in a void 129 inside the negative electrode mixture layer 120 becomes higher. Accordingly, in the present embodiment, a lithium ion occlusion and release reaction occurs satisfactorily between the negative electrode active material 121 surrounding the void 129 and an electrolyte in the void 129 during charging and discharging. Therefore, when the negative electrode plate 100 of the present embodiment produced using the negative electrode active material 121 that satisfies Formula (1) and has a high tap density is used, a reaction area of the negative electrode mixture layer 120 and the electrolyte is sufficient and it is possible to produce a lithium ion secondary battery having a low internal resistance.

In addition, in the wet granulated body forming process (S10), as a powder of the negative electrode active material 121, a powder having a tap density of 1.2 g/cm³ or less is preferably used. When a powder of the negative electrode active material 121 having a tap density of greater than 1.2 g/cm³ is used, the solvent 123 stored inside granulated particles is likely to be discharged to the outside of the granulated particles in the wet granulated body 130.

Thereby, when the wet granulated body 130 in which the solvent 123 is discharged to the outside of granulated particles is used, and the mixture layer forming device 1 performs the negative electrode mixture layer forming process (S11), transfer failure or the like may occur. Specifically, the film forming sheet 131 formed at the first opposing position A is not appropriately adhered to the second roll 20 and a part of the negative electrode mixture material may adhere to the first roll 10 that has passed the first opposing position A as a deposit. Moreover, at the second opposing position B, the film forming sheet 131 on the second roll 20 is not appropriately transferred onto the negative electrode current collecting foil 110 and a part of the film forming sheet 131 that has not been transferred may remain on the second roll 20 that has passed the second opposing position B. When such a transfer failure or the like occurs, it is not possible to form the negative electrode mixture layer 120 having a uniform thickness on the negative electrode current collecting foil 110.

On the other hand, when a powder having a tap density of 1.2 g/cm³ or less is used as a powder of the negative electrode active material 121, it is possible to appropriately prevent the transfer failure or the like described above. This is because, when a powder of the negative electrode active material 121 having a tap density of 1.2 g/cm³ or less is used, it is possible for the wet granulated body 130 to appropriately store the solvent 123 inside granulated particles. Accordingly, when a powder of the negative electrode active material 121 having a tap density of 1.2 g/cm³ or less is used, it is possible to appropriately form the negative electrode mixture layer 120 having a uniform thickness on the negative electrode current collecting foil 110.

In addition, in the wet granulated body forming process (S10), a solid content ratio in the wet granulated body 130 is preferably set to 72 wt % or more. That is, a weight of a solid content (a negative electrode mixture material such as the negative electrode active material 121) with respect to the total weight of the wet granulated body 130 including the solvent 123 is preferably set to 72 wt % or more. When the solid content ratio is low and an amount of the solvent 123 is large, a large amount of the solvent 123 remains in the negative electrode mixture layer 120 after the negative electrode mixture layer forming process (S11).

On the other hand, when a solid content ratio of the wet granulated body 130 is set to 72 wt % or more, not much of the solvent 123 remains in the negative electrode mixture layer 120 after the negative electrode mixture layer forming process. This is because there is no need to perform a drying process or the like for removing the solvent 123 from the negative electrode mixture layer 120 after the negative electrode mixture layer forming process. Alternatively, even if the drying process is performed after the negative electrode mixture layer forming process, since an amount of the solvent 123 in the negative electrode mixture layer 120 is small, it is possible to reduce costs necessary for the drying process and perform the drying process in a short time. In addition, when the solid content ratio is set to 72 wt % or more and the wet granulated body 130 is formed, an amount of the solvent 123 is also small. Therefore, when the solid content ratio in the wet granulated body 130 is set to 72 wt % or more, it is possible to produce the negative electrode plate 100 in a short time at a low cost.

In addition, the solid content ratio in the wet granulated body 130 is preferably 80 wt % or less. This is because it is possible to appropriately form the wet granulated body 130 without deficiency of the solvent 123.

In addition, in order to check an effect of the present disclosure, the inventors performed an example according to the present embodiment and comparative examples. Conditions in the wet granulated body forming process according to the example were as follows.

Negative electrode active material: average particle size of 20 μm, tap density of 0.80 g/cm³
Binding material: CMC
Solvent: ion exchanged water
Solid content ratio: 72 wt %
Negative electrode active material:binding material=99.2 wt %:0.8 wt %

That is, in the example, a powder of the negative electrode active material satisfying Formula (1) described above was used. In addition, in the example, the prepared wet granulated body and a copper foil as a negative electrode current collecting foil were used, the above-described mixture layer forming device 1 was used to perform a negative electrode mixture forming process, and thus a negative electrode plate was prepared.

Unlike the example, in Comparative Example 1, as a powder of the negative electrode active material, a negative electrode active material that failed to satisfy Formula (1) was used. A powder of the negative electrode active material used in Comparative Example 1 had an average particle size of 20 μm and a tap density of 0.65 g/cm³. Here, in Comparative Example 1, a negative electrode plate was prepared under the same conditions as in the example except that a different negative electrode active material powder was used.

In addition, in Comparative Example 2, a negative electrode plate was prepared using a paste method without the wet granulated body forming process and the negative electrode mixture layer forming process. That is, in Comparative Example 2, a paste obtained by dispersing a negative electrode active material and a binding material in a solvent was applied to a surface of a negative electrode current collecting foil, the solvent in the paste was then dried and removed, a negative electrode mixture layer was thus formed and a negative electrode plate was prepared. In addition, in Comparative Example 2, the same negative electrode active material powder as in Comparative Example 1 was used.

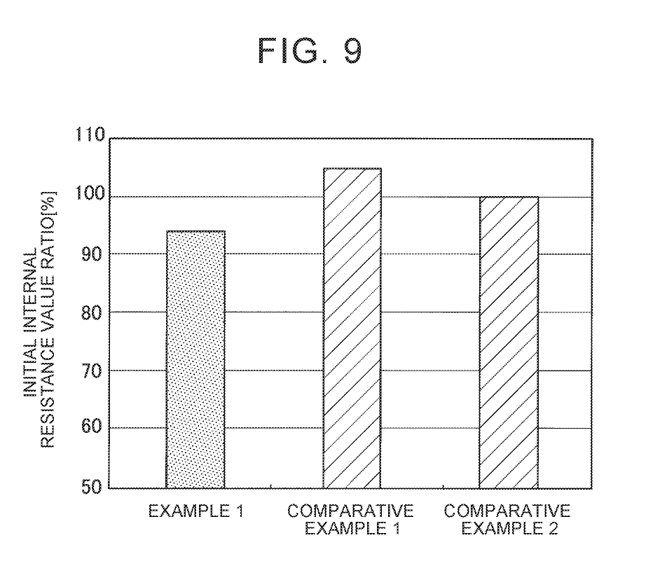

Furthermore, experimental lithium ion secondary batteries using the negative electrode plates of the example, Comparative Example 1, and Comparative Example 2 were prepared. All of the experimental batteries were prepared under the same conditions except for the negative electrode plate. Here, FIG. 9 shows initial internal resistances obtained from the experimental batteries using the negative electrode plates of the example, Comparative Example 1, and Comparative Example 2. Also, FIG. 9 shows initial internal resistances of the experimental batteries according to the example, Comparative Example 1, and Comparative Example 2 as an initial internal resistance value ratio that was calculated as a ratio of an initial internal resistance value of each experimental battery with respect to an initial internal resistance value of the experimental battery according to Comparative Example 2.

As shown in FIG. 9, the experimental battery using the negative electrode plate of Comparative Example 1 had a higher initial internal resistance than the experimental batteries using the negative electrode plates of the example and Comparative Example 2. The negative electrode plate of Comparative Example 1 was prepared using a powder of a negative electrode active material that failed to satisfy Formula (1) and had a low tap density. Therefore, in the negative electrode plate of Comparative Example 1, as described above, in the negative electrode mixture layer forming process, the negative electrode active material positioned on the surface of the negative electrode mixture layer of the negative electrode plate was crushed. Accordingly, in the experimental battery according to Comparative Example 1, an initial internal resistance was considered to have become higher.

Therefore, the experimental battery using the negative electrode plate of the example had a lower initial internal resistance than the experimental battery using the negative electrode plate of Comparative Example 1. The negative electrode plate of the example was prepared using a powder of the negative electrode active material that satisfied Formula (1) and had a high tap density. Therefore, unlike the negative electrode plate of Comparative Example 1, in the negative electrode plate of the example, the negative electrode active material positioned on the surface of the negative electrode mixture layer of the negative electrode plate was not crushed in the negative electrode mixture layer forming process and a charge and discharge reaction occurred satisfactorily. Moreover, it was confirmed that the experimental battery according to the example had an initial internal resistance that was reduced about 6% compared to the experimental battery according to Comparative Example 2. Accordingly, it was confirmed that the negative electrode plate according to the present embodiment can reduce an internal resistance of the lithium ion secondary battery.

Also, glossiness of the negative electrode plate can be obtained in order to determine whether the negative electrode plate according to the present embodiment by which an initial internal resistance of a lithium ion secondary battery is reduced is appropriately produced. As described above using FIG. 7, in the negative electrode plate produced using the negative electrode active material that failed to satisfy Formula (1), the negative electrode active material positioned on the surface of the negative electrode mixture layer was flattened and crushed. Therefore, in the negative electrode plate produced using the negative electrode active material that failed to satisfy Formula (1), glossiness was expressed on the surface of the negative electrode mixture layer and a glossiness was high.

On the other hand, in the negative electrode plate according to the present embodiment produced using the negative electrode active material satisfying Formula (1), as shown in FIG. 8, the negative electrode active material positioned on the surface of the negative electrode mixture layer was not crushed. That is, in the negative electrode plate according to the present embodiment, not much glossiness was expressed on the surface of the negative electrode mixture layer, and the glossiness was lower than that of the negative electrode plate produced using the negative electrode active material that failed to satisfy Formula (1).

Here, a threshold value of glossiness is set. When glossiness measured for the produced negative electrode plate is equal to or less than the threshold value, the plate can be determined as a non-defective plate. For the threshold value of the glossiness, glossiness obtained from the negative electrode plate that was produced using the negative electrode active material according to the present embodiment that satisfied Formula (1) and can produce a lithium ion secondary battery having a low initial internal resistance can be used as a reference. Thereby, when a non-defective negative electrode plate is determined using the glossiness, even if there is a defective negative electrode plate in which the negative electrode active material on the surface of the negative electrode mixture layer is crushed, it is possible to appropriately screen the defective negative electrode plate before the lithium ion secondary battery is produced.

As described above in detail, in the present embodiment, the negative electrode plate 100 is produced through the wet granulated body forming process and the negative electrode mixture layer forming process. Then, in the wet granulated body forming process, as a powder of the negative electrode active material 121, a powder whose average particle size and tap density satisfy Formula (1) and whose tap density is high is used. Therefore, in the negative electrode mixture layer forming process, it is possible to prevent particles of the negative electrode active material 121 from being crushed due to a compression force received from a pair of rolls. Accordingly, it is possible to produce the negative electrode plate 100 while preventing the gap 128 connected to the void 129 inside the negative electrode mixture layer 120 from being blocked. As a result, it is possible to implement a method of producing a negative electrode plate through which it is possible to reduce an internal resistance of a battery.

Note that the present embodiment is only an example and does not limit the present disclosure. Accordingly, it should be noted that various improvements and modifications can be made without departing from the spirit and scope of the present disclosure. For example, while a case in which the negative electrode mixture layer 120 is formed only on the first surface 111 of the negative electrode current collecting foil 110 has been described in the above embodiment, the negative electrode mixture layer 120 can be formed on the second surface 112 of the negative electrode current collecting foil 110. The negative electrode mixture layer 120 can be formed on the second surface 112 of the negative electrode current collecting foil 110 in the same manner as in the formation on the first surface 111 described in the above embodiment.

What is claimed is:

1. A method of producing a negative electrode plate including a negative electrode mixture layer on a negative electrode current collecting foil comprising:
mixing a negative electrode mixture material containing a negative electrode active material and a binding material with a solvent and forming a wet granulated body; and
rolling the wet granulated body to pass through a gap between a pair of rolls, molding the wet granulated body in a sheet form, and adhering the wet granulated body molded in the sheet form to a surface of the negative electrode current collecting foil,
wherein, when the wet granulated body is formed, a powder whose average particle size X μm and tap density Y g/cm³ satisfy the following formula: Y≧0.0139X+0.4386, is used as a powder of the negative electrode active material.

2. The method of producing the negative electrode plate according to claim 1,
wherein, when the wet granulated body is formed, a powder having a tap density of 1.2 g/cm³ or less is used as the powder of the negative electrode active material.

3. The method of producing the negative electrode plate according to claim 1,
wherein, when the wet granulated body is formed, a weight of the negative electrode mixture material with respect to a total weight of the negative electrode mixture material and the solvent is 72 wt % or more.

4. The method of producing the negative electrode plate according to claim 3,
wherein, when the wet granulated body is formed, the weight of the negative electrode mixture material with respect to the total weight of the negative electrode mixture material and the solvent is 80 wt % or less.
